(19) United States
(12) Patent Application Publication
(10) Pub. No.: US 2015/0032670 A1
(43) Pub. Date: Jan. 29, 2015

(54) Avatar Having Optimizing Artificial Intelligence for Identifying and Providing Relationship and Wellbeing Recommendations

(71) Applicant: Robert Brazell, Salt Lake City, UT (US)

(72) Inventor: Robert Brazell, Salt Lake City, UT (US)

(21) Appl. No.: 14/444,962

(22) Filed: Jul. 28, 2014

Related U.S. Application Data
(60) Provisional application No. 61/859,062, filed on Jul. 26, 2013.

(51) Int. Cl. G06N 5/04

(52) U.S. Cl. CPC G06N 5/04
USPC 706/11; 706/46

(57) ABSTRACT

An avatar having artificial intelligence for identifying and providing relationship or wellbeing recommendations is provided. The avatar acts as an electronic representation of a user. The avatar searches available information and makes recommendations to the user based on information received from the user or other sources regarding the user's relationship with another person or the user's wellbeing. In this way, the avatar continually learns more about the user to improve future recommendations to enhance the user's wellbeing and relationship with the other person.

### CROSS-REFERENCE TO RELATED APPLICATIONS

This application claims the benefit of U.S. Provisional Patent Application No. 61/859,062 which was filed on Jul. 26, 2013.

### BACKGROUND

Most people desire to develop a strong relationship with a mate. However, it is often difficult to know how to develop or strengthen a relationship with another person. For example, even after many years of marriage, a person may not be aware of personal changes he can make or actions he can perform that would strengthen his relationship with his wife.

Similarly, people generally desire to enhance their wellbeing. Although most people have a general understanding of various activities, habits, or behaviors that will enhance wellbeing, many do not know how to specifically implement such activities, habits, or behaviors to enhance their own wellbeing at a given time or in a given situation.

### BRIEF SUMMARY

The present invention extends to methods, systems, and computer program products for implementing an avatar having optimizing artificial intelligence for identifying and providing relationship recommendations. The avatar acts as an electronic representation of a user. The avatar searches available information (e.g. on the internet) and makes recommendations to the user based on information received from the user or other sources regarding the user's relationship with another person. In this way, the avatar continually learns more about the user to improve future recommendations to enhance the user's relationship with the other person.

The avatar can be configured to frequently search for available information regarding enhancing relationships. The avatar can draw from this information as well as information it has learned about a user and the user's mate in determining a recommendation to present to the user. For example, the avatar can identify changes that other users sharing characteristics with the user have made to enhance their relationship with a mate that shares characteristics with the user's mate. In other words, the avatar can be configured to learn what changes in behavior have enhanced relationships between other similar users and recommend that the user make similar changes to improve his relationships.

In one embodiment, the present invention is implemented as a method for providing a relationship recommendation to a user. User input that identifies personal characteristics of a user and a user's mate is received. Relationship information is searched to identify one or more behaviors that have successfully enhanced the relationship between people having characteristics in common with the user and the user's mate. One or more recommendations are then provided to the user. The one or more recommendations identify one or more behaviors that the user can perform to enhance the user's relationship with the user's mate. Feedback is received from the user regarding whether the one or more recommended behaviors were effective at enhancing the relationship between the user and the user's mate. One or more additional behaviors are then identified to recommend to the user based on the received feedback. Then, one or more additional recommendations are provided to the user. The one or more additional recommendations identify the one or more additional behaviors.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1-2 illustrate an example computer environment in which the present invention can be implemented; and

FIG. 3 illustrates a flowchart of an example method for providing a relationship recommendation to a user.

### DETAILED DESCRIPTION

The present invention extends to methods, systems, and computer program products for implementing an avatar having optimizing artificial intelligence for identifying and providing relationship recommendations. The avatar acts as an electronic representation of a user. The avatar searches available information (e.g. on the internet) and makes recommendations to the user based on information received from the user or other sources regarding the user's relationship with another person. In this way, the avatar continually learns more about the user to improve future recommendations to enhance the user's relationship with the other person.

The avatar can be configured to frequently search for available information regarding enhancing relationships. The avatar can draw from this information as well as information it has learned about a user and the user's mate in determining a recommendation to present to the user. For example, the avatar can identify changes that other users sharing characteristics with the user have made to enhance their relationship with a mate that shares characteristics with the user's mate. In other words, the avatar can be configured to learn what changes in behavior have enhanced relationships between other similar users and recommend that the user make similar changes to improve his relationships.

In one embodiment, the present invention is implemented as a method for providing a relationship recommendation to a user. User input that identifies personal characteristics of a user and a user's mate is received. Relationship information is searched to identify one or more behaviors that have successfully enhanced the relationship between people having characteristics in common with the user and the user's mate. One or more recommendations are then provided to the user. The one or more recommendations identify one or more behaviors that the user can perform to enhance the user's relationship with the user's mate. Feedback is received from the user regarding whether the one or more recommended behaviors were effective at enhancing the relationship between the user and the user's mate. One or more additional behaviors are then identified to recommend to the user based on the received feedback. Then, one or more additional recommendations are provided to the user. The one or more additional recommendations identify the one or more additional behaviors.

Example Computer Architecture

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

Example Computer Environment

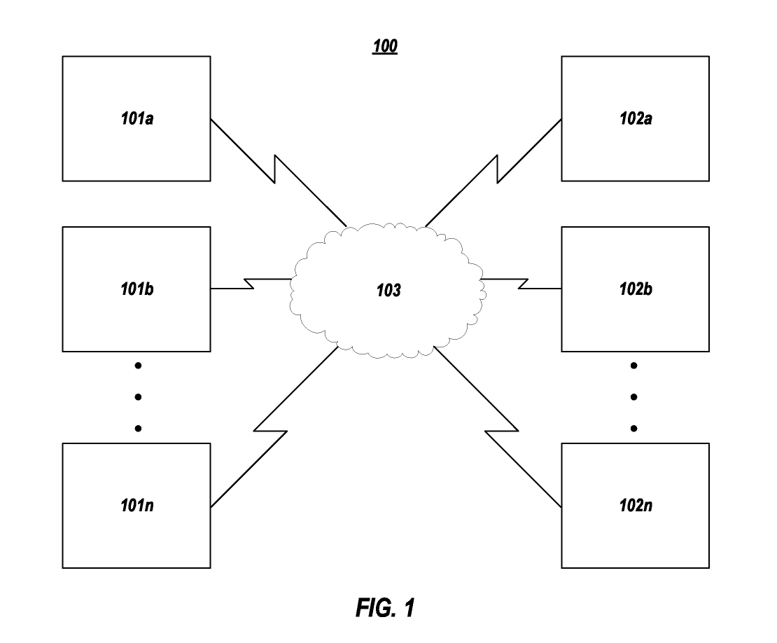

FIG. 1 illustrates an example computer environment 100 in which the present invention can be implemented. Computer environment 100 includes server computing systems 101a-101n and client computing devices 102a-102n which are connected via a network 103. Computer environment 100 in a typical environment can represent the internet.

Server computing systems 101a-101n represent any type of computer system connected to network 103 that stores content accessible from one or more of client computer devices 102a-102n. For example, each of server computing systems 101a-101n can comprise any number of computer systems or resources such as a single server or a cloud of interconnected computer resources. In other words, the present invention should not be limited to any particular computer or network configuration or infrastructure.

Client computing devices 102a-102n can represent any type of computing device capable of communicating with any of server computing systems 101a-101n over network 103. Examples of client computing devices 102a-102n include desktop computers, laptop computers, tablets, mobile phones, other smart electronic devices, etc. Although in most implementations, network 103 will be the internet, any type of network or direct connection between a client computer device 102 and a server computing system 101 could be used in addition to or in place of the internet.

Identifying and Providing Relationship Recommendations

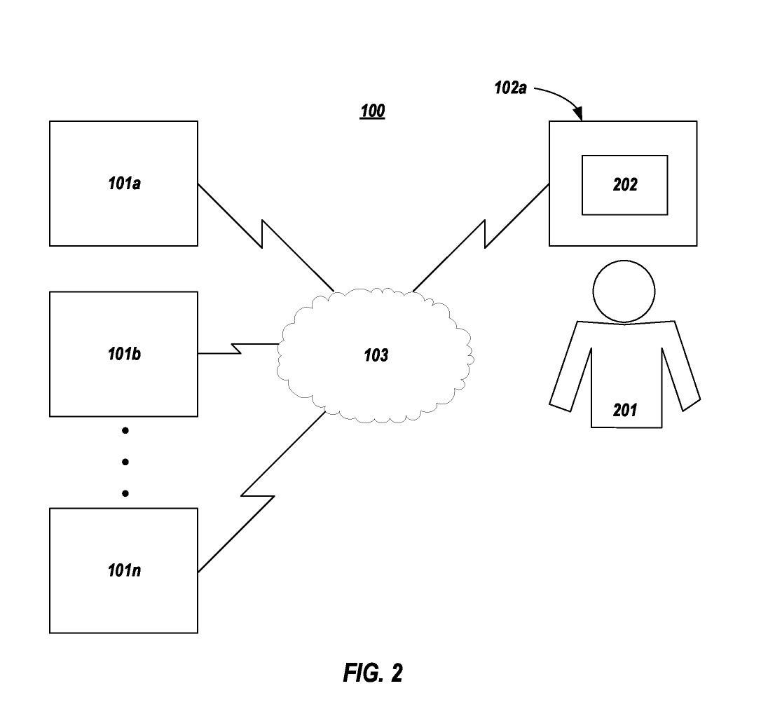

FIG. 2 represents computer environment 100 when a user 201 is using client computing device 102a to communicate with an avatar 202 in accordance with one or more embodiments of the invention. Avatar 202 comprises computer executable logic for obtaining information from user 201, searching for and identifying relevant information available via network 103, and using the information obtained from the user and via network 103 to present relationship recommendations to user 201. In some embodiments, avatar 202 can be displayed on a computer device as a person, character, animal, or other figure which interacts with user 201.

Although avatar 202 is shown as being located on client computing device 102a, it is to be understood that not all of the logic for implementing avatar 202 needs to be located on client computing device 102a. For example, avatar 202 can be based on one or more of server computer systems 101a-101n (e.g. server-based or cloud-based) with a user interface being provided locally on client computing device 102a to interface with user 201. Similarly, logic for implementing avatar 202 can be stored locally on client computing device 102a while the information learned by avatar 202 can be hosted partially or entirely on one or more of server computing systems 101a-101n. Of course, logic for implementing avatar 202 can be provided on multiple of client computing devices 102a-102n such as when user 201 uses a home computer, a work computer, and a mobile phone/tablet to interface with avatar 202. Accordingly, the specific manner in which avatar 202 is hosted is not essential to the invention.

Avatar 202 continually receives information via network 103 and from user 201 to enable avatar 202 to learn to identify changes user 201 can make to enhance his relationship with a mate. The information received from user 201 can include information received from user 201 about user 201 or about user 201's mate and information derived from user 201's responses to previously presented recommendations. A user's mate can include any person with which the user has an intimate relationship such as a spouse, boyfriend, or girlfriend. In some embodiments, mate can be construed broadly to encompass a person with whom the user has a close, but non-intimate relationship, such as a family member or a close friend.

For example, avatar 202 can collect characteristics of user 201 and of user 201's mate. These characteristics can include user 201's or user 201's mate's likes, dislikes, preferences, hobbies, etc. These characteristics can relate to user 201's or user 201's mate's personality, habits, character, beliefs, goals, etc.

Characteristics of other user's and other user's mates can also be collected (e.g. via other avatars) to enable the creation of a database of characteristics. Information can also be obtained regarding behaviors that are successful in enhancing a relationship between people having certain characteristics. Avatar 202 can use this information to identify what behavioral changes to recommend to user 201 to enhance user 201's relationship with his mate.

Some services exist that use characteristics of users to identify a pair of users that are likely to be compatible in a relationship. In contrast to such services, the present invention uses knowledge of the characteristics of two people already in a relationship or desiring to establish a relationship and identifies how the two people can change their behavior to establish or enhance their relationship with each other.

For example, the present invention can be used by spouses to receive recommendations regarding how one or both of the spouses can modify his or her behavior to enhance their relationship. These behavioral modifications can include modifications to enhance an emotional, spiritual, or sexual connection between the spouses.

Much information also exists regarding how to enhance a relationship with another person such as information in magazines, books, or online sources. However, such information can be minimally helpful because it is generalized for an average relationship and therefore may not be helpful or may even be harmful to a particular user's relationship. Further, it can be difficult for an average person to read this information and identify recommendations that he believes will be most effective.

To facilitate the identification of recommendations that are likely to be most beneficial to a particular user, avatar 202 can be configured to generate customized recommendations for the user. By customizing recommendations, avatar 202 becomes much more helpful to the user. In particular, even though a user may be capable of researching the available information on his own, and because of the large amount and complexity of the information, it may require an inordinate amount of time and effort for the user to identify a similar recommendation on his own. Because avatar 202 learns about the user as the user interacts with avatar 202, avatar 202 can contain sufficient artificial intelligence to make customized recommendations that will approximate the recommendation a user would make for himself if he were to fully research potential ways to enhance his relationship. Accordingly, avatar 202 can free the user from having to invest the time and effort to stay apprised of all the possible behaviors and to identify which behaviors will be most successful in enhancing his relationship.

In some embodiments, characteristic-to-behavior mappings can be created to facilitate the identification of recommended behaviors given one or more characteristics of a user. These mappings can define behaviors that have been found to be effective when one or both of the people in the relationship have the characteristic to which the behavior is mapped.

For example, by analyzing characteristics of users as well as which behaviors have proven to be effective for enhancing the relationship of each user with a mate, characteristic-to-behavior mappings can be created and optimized over time. Once these mappings have been created, an avatar can identify a recommendation to present to a particular user by identifying which characteristics the particular user and/or his mate has, and recommending behaviors mapped to the characteristics.

One way in which the system can identify whether a recommended behavior is effective for enhancing a relationship is by receiving feedback from a user to which the behavior was recommended. For example, if avatar 202 recommends a particular behavior to user 201, and user 201 provides feedback that the recommended behavior was effective, avatar 202 can update the stored information accordingly such as by creating a mapping between one or more characteristics and the behavior (if one did not already exist) or by modifying an existing mapping (e.g. by adding a characteristic pertaining to the user or the user's mate to the mapping, adding a behavior to the mapping, etc.).

In some embodiments, a general database of characteristic-to-behavior mappings can be maintained that is based on information obtained from all users of the system. In some embodiments, user specific mappings can also be maintained such as by customizing mappings in the general database or by creating new custom mappings for a particular user. In any case, avatar 202 can be configured to identify which behaviors will be most effective at strengthening user 201's relationship with a mate and to recommend such behaviors.

A characteristic-to-behavior mapping can be one-to-one, one-to-many, or many-to-one. For example, a simple mapping can define that a behavior A is effective when the male has characteristic A. A complex mapping can define that a behavior B is effective when the male has characteristics B, C, and D. Similarly, a complex mapping can define that a behavior C is effective when the male has characteristic C and the female has characteristic E. Also, a complex mapping can define that behaviors D and E are effective in combination when the male has characteristics A, F, and G and the female has characteristic H. In other words, the system can be configured to process the characteristics of individual users as well as couples along with the behaviors that have proven to be beneficial to such couples to identify patterns of behaviors that are effective when certain characteristics are present in the relationship. These patterns can be recorded as characteristic-to-behavior mappings for easy and quick access by avatars of users.

Also, because avatar 202 can continually learn more about user 201 by receiving feedback from user 201 regarding which recommendations were successfully followed, avatar 202 can refine its ability to make appropriate recommendations. For example, some methodologies have been created for categorizing a person into one of various groups such as groups which define how the person communicates love. In such methodologies, the person must learn about himself and his spouse to be able to identify in which grouping he or his spouse belongs.

In contrast to such methodologies, because avatar 202 can continually learn about user 201, avatar 202 can independently identify recommendations that are customized for user 201. In other words, user 201 need not invest the time to understand each of his own characteristics in order to identify an appropriate grouping or classification that he falls under. Instead, avatar 202 can learn more about user 201 based on feedback user 201 provides in response to avatar 202's recommendations. In this way, the more user 201 interacts with avatar 202, the more accurate and appropriate avatar 202's recommendations will become. User 201's role can therefore be limited to providing confirmation whether a recommendation was effective. Accordingly, user 201 can be freed from the burden of researching on his own the changes he should make to enhance his relationship.

Because avatar 202 may not initially know many of user 201's characteristics, preferences, etc., avatar 202 can initially request information from user 201 and rely on more generalized recommendations. Then, as avatar 202 accumulates substantial knowledge of user 201's characteristics, user 201's mate's characteristics, and any particular unique attributes within the relationship, avatar 202 can present recommendations based mainly on what avatar 202 has learned about user 201. In this manner, avatar 202 can provide a highly personal level of recommendations to user 201 to more successfully assist user 201 in enhancing his relationship.

For example, because many avatars (e.g. representing many different users and their relationships) can be continually collecting information about characteristics of users and what behaviors are effective for each user, a highly detailed collection of character-to-behavior mappings can be created and optimized over time. Each avatar, including avatar 202, can access these mappings, and, using the knowledge of the characteristics of the user that the avatar represents, can identify the most relevant mappings for the user.

For example, over time the mappings can be refined to contain a large number of characteristics for a user and the user's mate. A particular avatar can then compare what it knows about its user to the characteristics of these mappings to identify mappings having the highest similarity of characteristics. The avatar can then know that the behaviors associated with these mappings are likely to be successful for the user, and can make recommendations accordingly.

The user's feedback can then be used to further refine mappings. For example, if a group of users have provided feedback that a particular behavior is not effective, it can be determined if the group of users share a common characteristic. If a common characteristic is found, the presence of the common characteristic can be used to prevent the particular behavior from being recommended to another user having the common characteristic. This can be accomplished by refining the mapping to include a condition that a user not possess the common characteristic or by creating a new mapping that associates the common characteristic and the other shared characteristics with a different behavior.

A recommendation can be provided to the user or to the user's mate. Also, the recommendation can be based on a characteristic or condition of the user or the user's mate. For example, avatar 202 can be configured to receive information defining user 201's mate's current mental state such as by receiving the information from an avatar representing the user 201's mate. Avatar 202 can then recommend that user 201 perform some action towards his mate that will likely improve the current mental state of user 201's mate. Accordingly, avatars representing a user and a user's mate can interact to make information about the user and the user's mate available to each avatar to assist in identifying the most beneficial recommendation given the user's or user's mate's current state.

The above described features can be used to provide real-time recommendations based on a user's or a user's mate's current condition. For example, a user 201 can provide frequent input to avatar 202 (e.g. via voice interaction with avatar 202 such as when avatar 202 is provided as an application of a smart phone or other computing device, via email or text to an address representing avatar 202, etc.). This input can relate to many different types of conditions, feelings, desires, events, occurrences, etc. that the user may be or have experienced.

For example, user 201 can inform avatar 202 how the user slept, whether the user exercised, whether the user desires to be intimate, whether the user is hungry or desires to eat a particular food, whether the user desires to engage in some action, etc. Similarly, user 201 can also inform avatar 202 that he is feeling sad, happy, stressed, or some other emotion. In short, user 201 can provide any type of input to avatar 202 which input avatar 202 can use, possibly in conjunction with input from user 201's mate, to identify a recommendation for user 201 (or possibly for user 201's mate). These recommendations can be based at least partially on information that avatar 202 has acquired about user 201 so that the recommendation is customized to be most likely to enhance the wellbeing of user 201.

These recommendations can be a recommendation for user 201 to individually perform an action, to perform an action towards his mate, or to perform an action involving one or more other individuals. For example, if user 201 is feeling stressed, avatar 202 can attempt to identify the reasons for the stress based on what avatar 202 knows about user 201 (e.g. what user 201 has told avatar 202 about what he is doing), and can then make a recommendation to reduce the stress. This recommendation can be made to user 201, to user 201's mate (e.g. via user 201's mate's avatar or directly to user 201's mate), or to both user 201 and user 201's mate.

In some embodiments, avatar 202 can be configured to predict how user 201 may feel. For example, based on input provide to avatar 202, avatar 202 can identify that user 201 is soon likely to have a desire to be intimate. In such cases, avatar 202 can cause a recommendation to be made to user 201's mate suggesting that user 201's mate initiate a romantic encounter. Similarly, avatar 202 can recommend that user 201 perform various actions to enhance his mate's desire to be intimate. This recommendation can be based on input and/or feedback received from user 201 and/or user 201's mate regarding previous recommendations or previous romantic encounters. Avatar 202 can respond similarly when it is determined that user 201 is likely to feel some other emotion or desire. For example, avatar 202 can identify that user 201 is likely to become stressed and can recommend a stress reducing activity. In this way, avatar 202 can proactively work to prevent negative feelings user 201 may experience and to enhance user 201's wellbeing.

This type of predictive recommendation generation can also be beneficial in proactively enhancing the relationship between user 201 and his mate. Because the relationship between user 201 and user 201's mate can be greatly influenced by each individual's wellbeing, avatar 201 can constantly attempt to identify recommendations to enhance user 201's wellbeing and the wellbeing of user 201's mate. Accordingly, the present invention can be implemented to continuously monitor a user's physical and mental wellbeing as well as the wellbeing of his relationship with his mate, and make recommendations to both proactively enhance user 201's wellbeing and to address problems affecting user 201's wellbeing.

In some embodiments, avatar 202 can be configured to receive information from one or more sensors worn by user 201. The sensors can be configured to sense one or more biometrics or other sensible parameters of the user. For example, the sensors can include a heart rate monitor, a blood glucose monitor, a blood oximeter, an activity monitor (e.g. a pedometer), etc. Using the information from the sensors, avatar 202 can become aware of the condition of user 201 even without user 201 directly providing information. In many cases, the information obtained from the sensors can be used to provide recommendations for exercising, dieting, or other health related activities. Such recommendations can be intended to enhance the health and wellbeing of the user.

Accordingly, in one example, a person can inform his avatar of his goals or desires relating to diet, exercise, cognitive enhancement, meditation, spirituality, or other aspects. Then, based on what the person eats, how he sleeps, how he works, how he exercises, and/or how he responds to stress (which the avatar may know via realtime detection (e.g. via sensors) or via input (either directly from the person or another source), the avatar can make recommendations about diet, exercise, sleep, or relaxation to enhance the person's wellbeing in the moment. Similarly, the avatar can provide recommendation for courting, wooing, performing kind acts to his partner or children, or enhancing other important relationships. The more data the avatar has about the person's goals, actions, feelings, etc., the better the recommendations from the avatar will become.

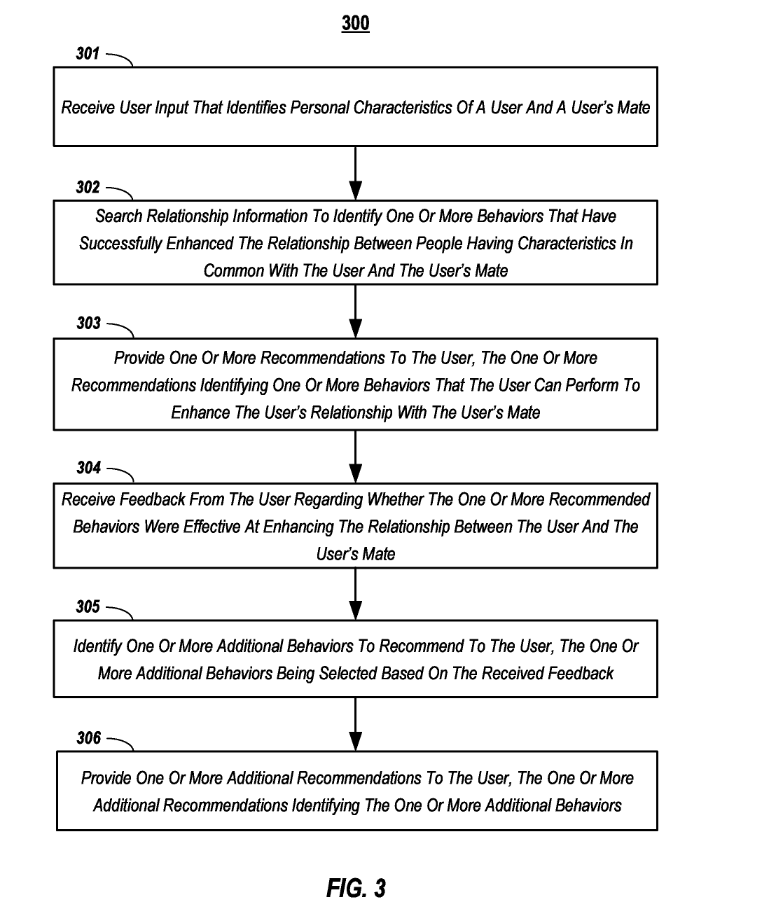

FIG. 3 illustrates a flowchart of an example method 300 for providing a relationship recommendation to a user. Method 300 will be described with reference to the figures.

Method 300 includes an act 301 of receiving user input that identifies personal characteristics of a user and a user's mate. For example, avatar 202 can receive input that identifies characteristics of user 201 and of user 201's mate. The characteristics can relate to user 201's or user 201's mate's personality, preferences, or interests, among others.

Method 300 includes an act 302 of searching relationship information to identify one or more behaviors that have successfully enhanced the relationship between people having characteristics in common with the user and the user's mate. For example, avatar 202 can search characteristic-to-behavior mappings to identify one or more behaviors that are mapped to one or more characteristics that user 201 and/or user 201's mate have.

Method 300 includes an act 303 of providing one or more recommendations to the user. The one or more recommendations identify one or more behaviors that the user can perform to enhance the user's relationship with the user's mate. For example, avatar 202 can recommend a behavior to user 201 to enhance user 201's relationship with user 201's mate.

Method 300 includes an act 304 of receiving feedback from the user regarding whether the one or more recommended behaviors were effective at enhancing the relationship between the user and the user's mate. For example, after attempting the behavior, user 201 can provide feedback to avatar 202 to inform avatar 202 whether the behavior was effective.

Method 300 includes an act 305 of identifying one or more additional behaviors to recommend to the user. The one or more additional behaviors are selected based on the received feedback. For example, avatar 202 can customize the selection of an additional behavior to recommend based on the feedback provided by user 201. In this way, avatar 202 learns more about user 201 and user 201's mate to be better able to make appropriate recommendations to enhance their relationship.

Method 300 includes an act 306 of providing one or more additional recommendations to the user, the one or more additional recommendations identifying the one or more additional behaviors. For example, avatar 202 can recommend the one or more additional behaviors to user 201 to assist user 201 in enhancing the relationship with user 201's mate.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by one or more computing devices, for providing a relationship recommendation to a user, the method comprising;
receiving user input that identifies personal characteristics of a user and a user's mate;
searching relationship information to identify one or more behaviors that have successfully enhanced the relationship between people having characteristics in common with the user and the user's mate;
providing one or more recommendations to the user, the one or more recommendations identifying one or more behaviors that the user can perform to enhance the user's relationship with the user's mate;
receiving feedback from the user regarding whether the one or more recommended behaviors were effective at enhancing the relationship between the user and the user's mate;
based on the received feedback, identifying one or more additional behaviors to recommend to the user; and
providing one or more additional recommendations to the user, the one or more additional recommendations identifying the one or more additional behaviors.

2. The method of claim 1, wherein the relationship information comprises characteristic-to-behavior mappings which each associate one or more behaviors with one or more characteristics of a person whose relationship was enhanced when the one or more associated behaviors was performed in the relationship.

3. The method of claim 2, wherein at least some of the characteristic-to-behavior mappings are generated from feedback received from a plurality of users to whom one or more mapped behaviors were recommended.

4. The method of claim 2, wherein at least some of the characteristic-to-behavior mappings are created by:
identifying a plurality of users which each have provided feedback that a first behavior was successful in enhancing a relationship between the user and a mate;
identifying one or more characteristics that each of the plurality of users share in common; and
creating a characteristic-to-behavior mapping between the one or more characteristics shared in common and the first behavior.

5. The method of claim 2, wherein the one or more behaviors are identified by:
identifying a first characteristic-to-behavior mapping that includes one or more characteristics of the user or the user's mate; and
selecting the one or more behaviors from the first characteristic-to-behavior mapping.

6. The method of claim 5, wherein the one or more additional behaviors are identified by:
identifying a second characteristic-to-behavior mapping that includes one or more of the same characteristics as the first characteristic-to-behavior mapping; and
selecting the one or more additional behaviors from the second characteristic-to-behavior mapping.

7. The method of claim 5, wherein the one or more additional behaviors are identified by:
identifying a plurality of users that each has provided feedback that the one or more behaviors of the first character-to-behavior mapping were effective in enhancing a relationship of the user;
identifying a second characteristic-to-behavior mapping that includes the one or more additional behaviors for which each of the plurality of users has provided feedback that the one or more additional behaviors were effective in enhancing a relationship of the user; and
selecting the one or more additional behaviors from the second characteristic-to-behavior mapping.

8. The method of claim 1, wherein the personal characteristics comprise one or more of personality, capabilities, preferences, beliefs, goals, habits, or interests of the user or the user's mate.

9. One or more computer storage media storing computer executable instructions which when executed by one or more processors implement a method for providing a relationship recommendation to a user, the method comprising;
receiving user input that identifies personal characteristics of a user and a user's mate;
searching relationship information to identify one or more behaviors that have successfully enhanced the relationship between people having characteristics in common with the user and the user's mate;
providing one or more recommendations to the user, the one or more recommendations identifying one or more behaviors that the user can perform to enhance the user's relationship with the user's mate;
receiving feedback from the user regarding whether the one or more recommended behaviors were effective at enhancing the relationship between the user and the user's mate;
based on the received feedback, identifying one or more additional behaviors to recommend to the user; and
providing one or more additional recommendations to the user, the one or more additional recommendations identifying the one or more additional behaviors.

10. The computer storage media of claim 9, wherein the relationship information comprises characteristic-to-behavior mappings which each associate one or more behaviors with one or more characteristics of a person whose relationship was enhanced when the one or more associated behaviors was performed in the relationship.

11. The computer storage media of claim 10, wherein at least some of the characteristic-to-behavior mappings are generated from feedback received from a plurality of users to whom one or more mapped behaviors were recommended.

12. The computer storage media of claim 10, wherein at least some of the characteristic-to-behavior mappings are created by:
identifying a plurality of users which each have provided feedback that a first behavior was successful in enhancing a relationship between the user and a mate;
identifying one or more characteristics that each of the plurality of users share in common; and
creating a characteristic-to-behavior mapping between the one or more characteristics shared in common and the first behavior.

13. The computer storage media of claim 10, wherein the one or more behaviors are identified by:
identifying a first characteristic-to-behavior mapping that includes one or more characteristics of the user or the user's mate; and
selecting the one or more behaviors from the first characteristic-to-behavior mapping.

14. The computer storage media of claim 13, wherein the one or more additional behaviors are identified by:
identifying a second characteristic-to-behavior mapping that includes one or more of the same characteristics as the first characteristic-to-behavior mapping; and
selecting the one or more additional behaviors from the second characteristic-to-behavior mapping.

15. The computer storage media of claim 13, wherein the one or more additional behaviors are identified by:
identifying a plurality of users that each has provided feedback that the one or more behaviors of the first character-to-behavior mapping were effective in enhancing a relationship of the user;
identifying a second characteristic-to-behavior mapping that includes the one or more additional behaviors for which each of the plurality of users has provided feedback that the one or more additional behaviors were effective in enhancing a relationship of the user; and
selecting the one or more additional behaviors from the second characteristic-to-behavior mapping.

16. The computer storage media of claim 9, wherein the personal characteristics comprise one or more of personality, capabilities, preferences, beliefs, goals, habits, or interests of the user or the user's mate.

17. A method, performed by one or more computing devices, for providing a relationship recommendation to a user, the method comprising;
receiving user input that identifies personal characteristics of a user and a user's mate;
searching relationship information to identify one or more behaviors that have successfully enhanced the relationship between people having characteristics in common with the user and the user's mate, the relationship information comprising characteristic-to-behavior mappings which each associate one or more behaviors with one or more characteristics of a person whose relationship was enhanced when the one or more associated behaviors was performed in the relationship such that the one or more behaviors that are identified are mapped to one or more of the personal characteristics of the user and the user's mate; and
providing one or more recommendations to the user, the one or more recommendations identifying the one or more behaviors that the user can perform to enhance the user's relationship with the user's mate.

18. The method of claim 17, further comprising:
receiving feedback from the user regarding whether the one or more recommended behaviors were effective at enhancing the relationship between the user and the user's mate;
based on the received feedback, identifying one or more additional behaviors to recommend to the user; and
providing one or more additional recommendations to the user, the one or more additional recommendations identifying the one or more additional behaviors.

19. The method of claim 17, wherein at least some of the characteristic-to-behavior mappings are created by:
identifying a plurality of users which each have provided feedback that a first behavior was successful in enhancing a relationship between the user and a mate;
identifying one or more characteristics that each of the plurality of users share in common; and
creating a characteristic-to-behavior mapping between the one or more characteristics shared in common and the first behavior.

20. The method of claim 18, wherein the one or more behaviors are identified by:
identifying a first characteristic-to-behavior mapping that includes one or more characteristics of the user or the user's mate; and
selecting the one or more behaviors from the first characteristic-to-behavior mapping;
and the one or more additional behaviors are identified by:
identifying a second characteristic-to-behavior mapping that includes one or more of the same characteristics as the first characteristic-to-behavior mapping; and
selecting the one or more additional behaviors from the second characteristic-to-behavior mapping.
